(19) United States
(12) Patent Application Publication
(10) Pub. No.: US 2011/0304088 A1
(43) Pub. Date: Dec. 15, 2011

(54) POSITIONING FIXTURE

(75) Inventor: Zhen-Hai LV, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/878,233

(22) Filed: Sep. 9, 2010

(30) Foreign Application Priority Data
Jun. 9, 2010 (CN) 201010195475.2

(51) Int. Cl. B25B 11/00

(52) U.S. Cl. 269/311; 269/309

(57) ABSTRACT

A positioning fixture includes a base and a holder. The base defines an arcuate notch and plurality of slots therein. At least one projection protrudes from the holder. The at least one projection is selectively received in one of the slots to allow the holder to hold a workpiece at a predetermined angle relative to the base.

### BACKGROUND

1. Technical Field

The disclosure generally relates to positioning fixtures and, particularly, to an adjustable positioning fixture.

2. Description of Related Art

Positioning fixtures are widely used in manufacturing or assembling processes to hold or support workpieces. Conventional positioning fixtures define a receiving space for fixing a workpiece in place to conveniently cut or grind the workpiece. When the workpiece has more than one surface to be machined, the positioning fixture cannot easily provide a suitable angle for working on the workpiece and so another fixture must be used

Therefore, there is room for improvement within the art.

### BRIEF DESCRIPTION OF THE DRAWINGS

Many aspects of the exemplary positioning fixture can be better understood with reference to the following drawings. The components in the drawings are not necessarily drawn to scale, the emphasis instead being placed upon clearly illustrating the principles of the positioning fixture. Moreover, in the drawings, like reference numerals designate corresponding parts throughout the several views, in which:

FIG. 1 is an exploded, isometric view of a first embodiment of a positioning fixture;

FIG. 2 is an isometric view of a holder of the positioning fixture of FIG. 1 from another aspect;

FIG. 3 is a side elevation assembled view of the positioning fixture of FIG. 1;

FIG. 4 is similar to FIG. 3, but showing the holder in another position;

FIG. 5 is an exploded, isometric view of a second embodiment of a positioning fixture; and

FIG. 6 is a side elevation, assembled view of the positioning fixture of FIG. 5.

### DETAILED DESCRIPTION

The disclosure is illustrated by way of example and not by way of limitation in the accompanying drawings. It should be noted that references to “an” or “one” embodiment in this disclosure are not necessarily to the same embodiment, and such references can include the meaning of “at least one” embodiment where the context permits.

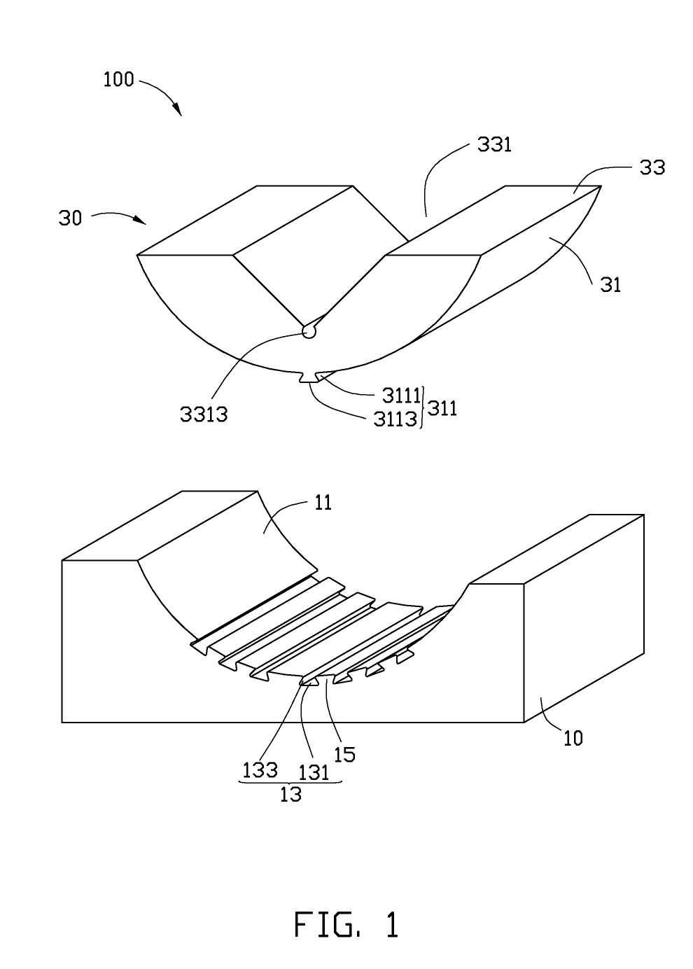

FIG. 1 illustrates a positioning fixture 100 to hold a workpiece (not shown) during either a machining operation or other process. The positioning fixture 100 includes a base 10 and a holder 30, and the holder 30 is adjustably secured to the base 10.

The base 10 is for holding the holder 30 at a predetermined position. An arcuate notch 11 is defined in the base 10. A plurality of spaced slots 13 of equal width are defined in the bottom surface of the notch 11. The distances between adjacent slots 13 may or may not be uniform to allow for a multitude of positioning options. Each slot 13 is cooperatively defined by a bottom wall 131 and two sidewalls 133. The two sidewalls 133 are oriented at an angle of about 30-150 degrees. A stopper block 15 is formed between every two adjacent slots 133.

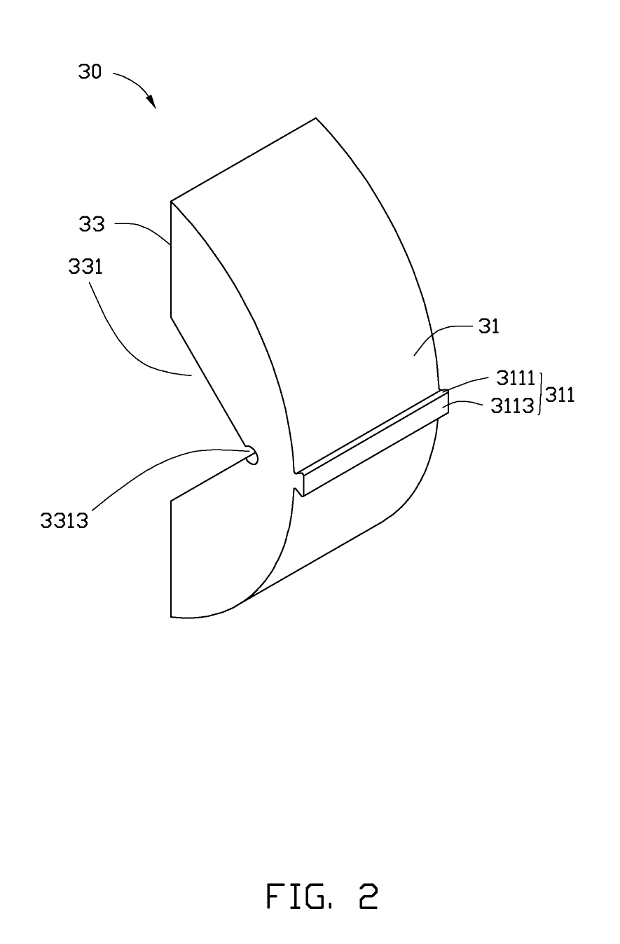

Referring to FIG. 2, the holder 30 is semi-cylindrical, and includes a curved surface 31 and a supporting surface 33 connected to the curved surface 31. A V-shaped receiving space 331 and a groove 3313 are defined in the holder 30, and the groove 3313 communicates with the receiving space 331. The receiving space 331 is for receiving the workpiece, and the groove 331 is for positioning the workpiece. A projection 311 protrudes from the curved surface 31. The projection 311 includes a planar resisting surface 3113, and two side surfaces 3111 corresponding to the sidewalls 133 of the base 10. The projection 311 is selectively received in one of the slots 13 and is retained by the stopper blocks 15 to secure the holder 30 to the base 10.

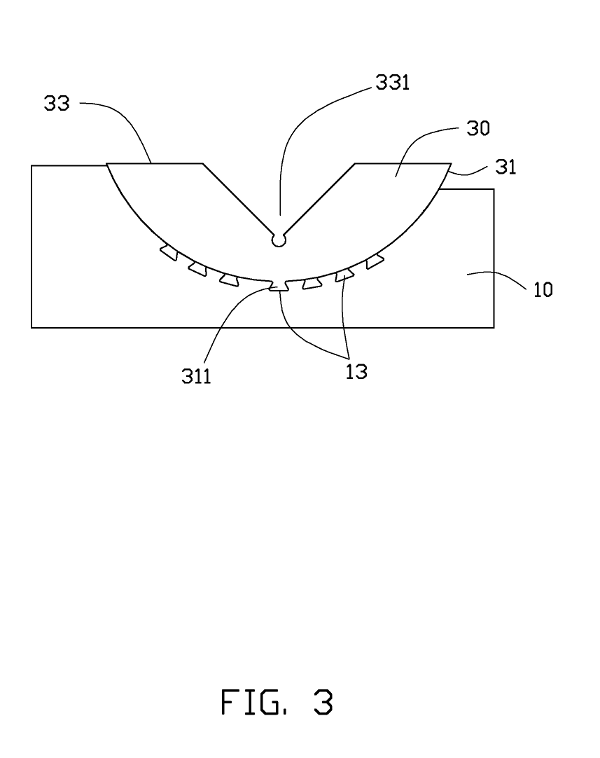

Referring to FIG. 3, during assembly, the projection 311 is aligned in one of the slots 13 and is pushed into the slot 13. Each side surface 3111 resists a corresponding sidewall 133, and the resisting surface 3113 resists the bottom wall 131, the projection 311 is retained by the stopper blocks 15, and the curved surface 31 resists the bottom surface of the notch 11.

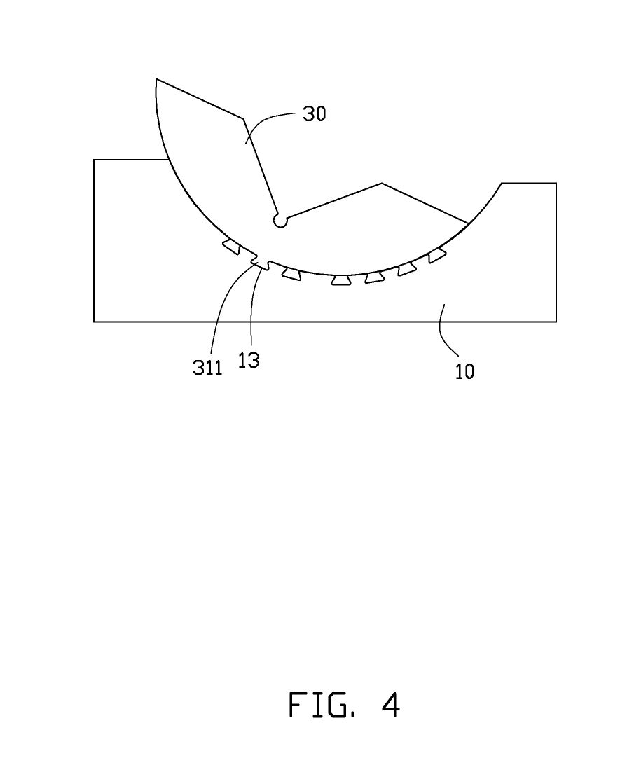

Referring to FIG. 4, when the positioning fixture 100 is used to hold a workpiece, one of the slots 13 is selected to receive the projection 311 therein. The workpiece is received in the receiving space 331 and is secured by a fastener (not shown), such as, a vacuum device or a bolt. The workpiece can also be held in place if the workpiece and the holder 30 are configured to magnetically attract to each other.

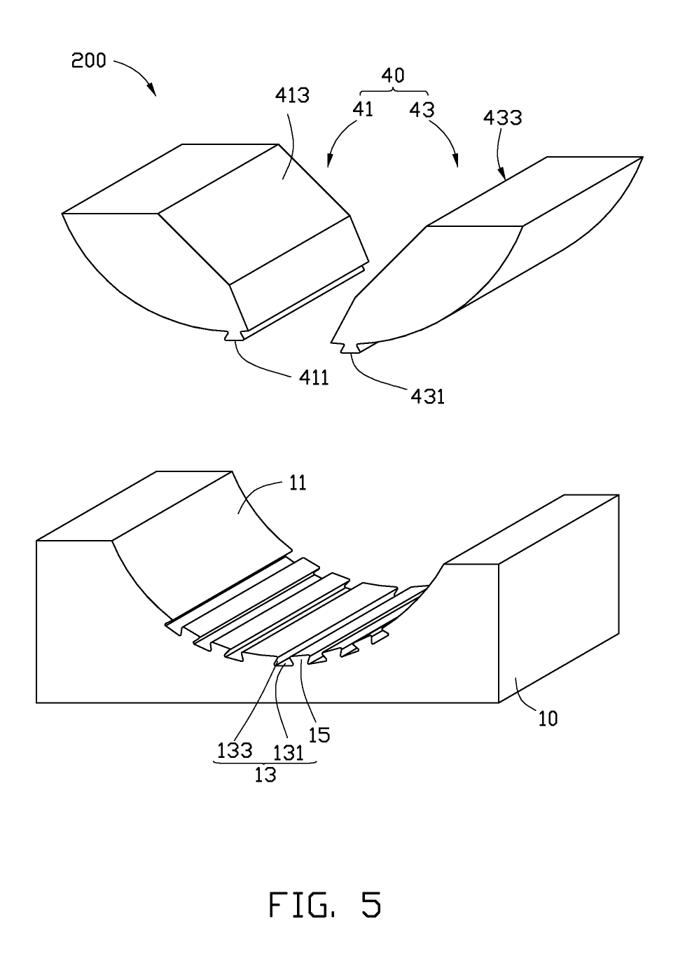

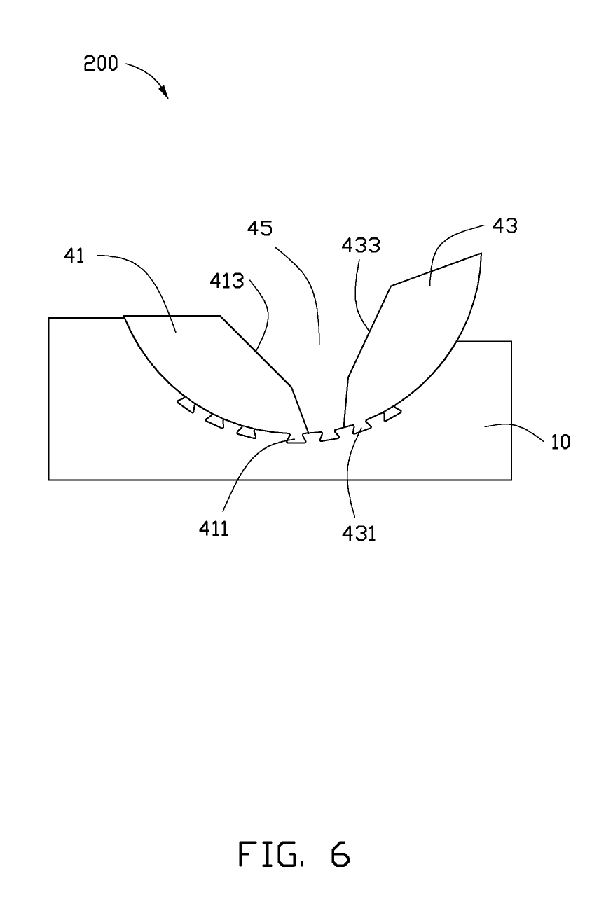

Referring to FIGS. 5 and 6, a second embodiment of a positioning fixture 200 includes a base 10 as described in the first embodiment, and a holder 40. The holder 40 includes a first supporting element 41 and a second supporting element 43. A projection 411 protrudes from the first supporting element 41. The first supporting element 41 includes a supporting surface 413 oriented at an angle with the projection 411. A projection 431 protrudes from the second supporting element 43. The second supporting element 43 includes a supporting surface 433. When the positioning fixture 200 is used to hold a workpiece, the projections 411 and 431 are respectively received in a corresponding slot 13, and a receiving space 45 is defined by the first supporting surface 431 and the second supporting surface 431. The first supporting element 41 and the second supporting element 43 can be selectively received in various of the slots 13 to allow a multitude of positioning options.

It is to be understood a distance between every two adjacent slots 13 can differ from each other, thus, the fixing fixture 100 can hold the workpiece in more optional positions.

In the exemplary embodiments of the positioning fixture, the base defines a plurality of spaced slots that can be variously selected to receive the projections of the holder, thus, the only one positioning fixture is needed to hold the workpiece in different positions as needed, thus, reducing the number of positioning fixtures needed and cutting costs.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A positioning fixture comprising:
a base defining an arcuate notch and a plurality of spaced slots therein, each slot communicating with the notch; and
a holder including at least one projection protruding from the holder, the at least one projection being selectively received in one of the slots to position the holder at a predetermined angle relative to the base.

2. The positioning fixture as claimed of claim 1, wherein each of the slots is cooperatively defined by a bottom wall and two sidewalls, oriented at an angle with respect to each other.

3. The positioning fixture as claimed of claim 2, wherein the angle is about 30-150 degrees.

4. The positioning fixture as claimed of claim 2, wherein the bottom wall is planar.

5. The positioning fixture as claimed of claim 2, wherein a stopper block is formed between adjacent slots, the projection is retained by the stopper block.

6. The positioning fixture as claimed of claim 1, wherein a receiving space and a groove are defined in the holder, the groove communicates with the receiving space.

7. The positioning fixture as claimed of claim 1, wherein the holder includes two supporting elements, each supporting element includes a supporting surface, and a receiving space is cooperatively defined by the supporting surfaces.

8. The positioning fixture as claimed of claim 1, wherein a distance between two adjacent slots differs from each other.

9. A positioning fixture comprising:
a base defining an arcuate notch and a plurality of slots therein, each slot communicating with the notch; and
a holder defining a receiving space for receiving a workpiece, the holder including a projection protruding therefrom, the projection being selectively received in one of the slots to position the holder at a predetermined angle relative to the base.

10. The positioning fixture as claimed of claim 9, wherein each of the slots is cooperatively defined by a bottom wall and two sidewalls oriented at an angle with respect to each other with each other.

11. The positioning fixture as claimed of claim 10, wherein the angle is about 30-150 degrees.

12. The positioning fixture as claimed of claim 10, wherein the bottom wall is planar.

13. The positioning fixture as claimed of claim 10, wherein a stopper block is formed between adjacent slots, the projection is retained by the stopper block.

14. The positioning fixture as claimed of claim 9, wherein a receiving space and a groove are defined in the holder, the groove communicates with the receiving space.

15. A positioning fixture comprising:
a base defining an arcuate notch and a plurality of slots, each slot communicating with the notch; and
a holder, the holder including two supporting elements, each supporting element including a projection, each projection being selectively received in one of the slots to position the holder at a predetermined angle relative to the base, a receiving space defined by the two supporting elements for receiving a workpiece.

16. The positioning fixture as claimed of claim 15, wherein each of the slots is cooperatively defined by a bottom wall and two sidewalls oriented at an angle with respect to each other.

17. The positioning fixture as claimed of claim 16, wherein the angle is about 30-150 degrees.

18. The positioning fixture as claimed of claim 16, wherein the bottom wall is planar.

19. The positioning fixture as claimed of claim 16, wherein a stopper block is formed between adjacent slots, the projection is retained by the stopper block.

20. The positioning fixture as claimed of claim 15, wherein a distance between two adjacent slots differs from each other.
